(19) United States
(12) Patent Application Publication
(10) Pub. No.: US 2019/0387734 A1
(43) Pub. Date: Dec. 26, 2019

(54) Drone Control For Animals And Birds

(71) Applicant: Sullivan Mews LLC, Otis Orchards, WA (US)

(72) Inventors: Brian E. Sullivan, Otis Orchards, WA (US); Kurt Kreiger, Billings, MT (US)

(73) Assignee: Sullivan Mews LLC, Otis Orchards, WA (US)

(21) Appl. No.: 16/446,014

(22) Filed: Jun. 19, 2019

Related U.S. Application Data
(60) Provisional application No. 62/687,944, filed on Jun. 21, 2018.

(51) Int. Cl. A01M 29/16; B64C 39/02

(52) U.S. Cl. CPC A01M 29/16; B64C 2201/146; B64C 2201/12; B64C 39/024

(57) ABSTRACT

Disclosed herein are a drone detonator for animal and bird control and a method for animal and bird control using the same. The detonator may include an actuator, a firing rod and a blank cartridge. The detonator may be detachably coupled to a drone. The actuator may move the firing rod from a first position to a second position to trigger detonation of the blank cartridge during drone flight. The actuator may be in communication with a remote control source. A method of animal and bird control using the drone detonator may include attaching the detonator to a drone, flying the drone to a target zone, and detonating the blank cartridge at the target zone.

### CROSS-REFERENCE TO RELATED APPLICATIONS

This application claims the benefit of the filing date of U.S. Provisional Patent Application No. 62/687,944 filed Jun. 21, 2018, the disclosure of which is hereby incorporated herein by reference.

### FIELD OF THE INVENTION

The present invention relates to an animal and bird control device and a method for using the same, and more particularly to a drone with a detonation mechanism for animal control and bird control, and a method for using the same.

### BACKGROUND OF THE INVENTION

Animal and bird control to deter pest animals and birds from certain areas is necessary for a variety of reasons. Unchecked animal or bird populations may cause considerable loss of crops and fruits in farms. Bird and animal droppings may create health-related problems and damage property. Airplane bird strikes at airports pose serious life safety concerns requiring bird control.

Current animal and bird control devices include physical, chemical or sonic deterrents. Physical deterrents include netting, spike systems, electrified wiring systems, etc. Deploying physical deterrents across large areas such as farms may be cost prohibitive. Chemical deterrents may cause unintended side effects and are generally restricted by many localities. Sonic avian deterrents such as predatory or distress calls of pest birds can be deployed over large areas. However, these deterrents have limited success because of their static nature. Pest animal and bird populations are known to recognize the static nature of these false threats, and adapt their behavior accordingly.

Therefore, there exists a need for an active animal and bird control device that overcomes the deficiencies of the current animal and bird control devices.

### BRIEF SUMMARY OF THE INVENTION

Disclosed herein are drones and drone detonators for animal and bird control and methods for controlling using the same.

In a first aspect of the present disclosure, a drone with a detonator is provided. The detonator may be formed to be removably attachable to the drone or may be integrated with the drone. The detonator may include a housing, a biased element and an actuator. The housing may define a chamber to receive and retain a blank cartridge. The biased element may be moveable from a first position to a second position by the actuator. A distal end of the biased element may be away from the blank cartridge in the first position and may contact the blank cartridge in the second position to detonate the blank cartridge.

In accordance with this first aspect, the detonator may be detachably connected to a drone. The distal end may contact the blank cartridge in the second position to fire the blank cartridge during drone flight.

In accordance with this first aspect, a blank cartridge dimension may be greater than a chamber dimension such that the blank cartridge forms an interference fit with the chamber. The biased element may be a spring-loaded rod. The spring-loaded rod may include a firing pin on a distal end. The spring may be a compression spring, being compressed with a compression spring load when the spring-loaded rod is in the first position. The compression spring load may be released by moving the spring-loaded rod from the first position to the second position. The compression load may be equal to or greater than a detonation force required for detonation of the blank cartridge. A proximal portion of the spring-loaded rod may have an arm extending transverse to the spring-loaded rod. The spring-loaded rod may be rotatable about a central axis such that the arm can be moved from a first lateral position to a second lateral position. When the spring-loaded rod is in the first position and the arm is in the first lateral position, at least a portion of the arm may rest on a proximal surface of the detonator. When the spring-loaded rod is in the second position and the arm is in the second lateral position, at least a portion of the arm may rest on a distal surface of the detonator. The actuator may include a movable band. The band may be configured to move the spring-loaded rod from the first position to the second position by moving the arm from the first lateral position to the second lateral position.

In accordance with this first aspect, the actuator may be in communication with a remote control source such that the actuator may be initiated by the remote control source to detonate the blank cartridge. The actuator may be initiated by a timer to detonate the blank cartridge.

In accordance with this first aspect, the drone may include a wireless transceiver configured to communicate with the remote control source via any wireless technologies such as radio frequency or Wi-Fi. The drone may be equipped with navigational capabilities such as GPS, Waypoint GPS navigation, cameras or thermal imaging to aid in deploying the drone to the target zone.

In accordance with second aspect of the present disclosure, a drone detonator for animal and bird control is provided. The drone detonator may include a plurality of housings, a plurality of biased elements and an actuator. Each housing may define a chamber to receive and retain a blank cartridge. Each biased element may be moveable from a first position to a second position by the actuator. A distal end of the biased elements may be located away from the blank cartridges in a first position and may contact the blank cartridges in the second position to detonate the blank cartridges.

In accordance with this second aspect, the plurality of housings may be arranged in a circular pattern. The actuator may be configured to individually detonate each of the blank cartridges.

In accordance with a third aspect of the present disclosure, a method for animal and bird control is provided. A method according to this aspect may include the steps of attaching a drone detonator to a drone, positioning a biased element to a first position, flying the drone to a target zone and detonating a blank cartridge. The detonator may include a housing defining a chamber to receive and retain a blank cartridge. The biased element may be moveable from the first position to a second position. An actuator may move the biased element from the first position to the second position. A distal end of the biased element may be away from the blank cartridge in the first position. The blank cartridge may be detonated by activating the actuator to move the biased element to the second position to contact the distal end with the blank cartridge.

In accordance with this third aspect, the step of detonating the blank cartridge may be performed by activating the actuator via a remote control source. The actuator may be in communication with the remote control source.

In accordance with a fourth aspect of the present disclosure, a method for animal and bird control is provided. A method according to this aspect may include the steps of attaching a drone detonator to a drone, flying the drone to a target zone and detonating a blank cartridge. The detonator may include an actuator, a firing rod and the blank cartridge. The step of detonating the blank cartridge may include activating the actuator to cause the firing rod to contact the blank cartridge.

In accordance with this fourth aspect, the step of detonating the blank cartridge may be performed by activating the actuator via a remote control source. The actuator may be in communication with the remote control source.

In accordance with a fifth aspect of the present disclosure, an apparatus for animal and bird control is provided. An apparatus according to this aspect may include a drone and a detonation device. The drone may include a wireless transceiver. The detonation device may include a housing, a biased element and an actuator. The housing may define a chamber to receive and retain a blank cartridge. The biased element may be moveable from a first position to a second position by the actuator. A distal end of the biased element may be away from the blank cartridge in the first position and may contact the blank cartridge in the second position to detonate the blank cartridge. The wireless transceiver may be adapted to receive remote signals to actuate the firing device in accordance with user control.

### BRIEF DESCRIPTION OF THE DRAWINGS

A more complete appreciation of the subject matter of the present invention and the various advantages thereof can be realized by reference to the following detailed description, in which reference is made to the following accompanying drawings:

FIG. 1 is a perspective view of a drone with an detonator according to one embodiment of the present disclosure;

FIG. 2 is a front view of the detonator of FIG. 1 showing firing rods in an unloaded state;

FIG. 3 is a front view of the detonator of FIG. 1 showing some firing rods in a loaded state;

FIG. 4 is a front detail view of the detonator of FIG. 1 showing a firing rod in a loaded state;

FIG. 5 is a perspective view of a frame of the detonator of FIG. 1;

FIG. 6 is a perspective view of a drone ring mount of the detonator of FIG. 1;

FIG. 7 is a perspective view of a frame ring mount of the detonator of FIG. 1;

FIG. 8 is a bottom view of the detonator of FIG. 1;

FIG. 9 is a perspective view of a base of the detonator of FIG. 1;

FIG. 10 is a top view of the detonator of FIG. 1;

FIG. 11 is a perspective view of the firing rod of the detonator of FIG. 1;

FIG. 12A is front view of the detonator of FIG. 1 showing a firing rod in the unloaded state;

FIG. 12B is a front view of the firing rod of FIG. 12A in a loaded state;

FIG. 13A is a front view of a stop used in conjunction with the detonator of FIG. 1;

FIG. 13B is a front view of the stop placed on the detonator of FIG. 1;

FIG. 14A is perspective view of a housing in a first position according to another embodiment of the present disclosure;

FIG. 14B is a perspective view of the housing of FIG. 14A in a second position;

FIG. 15 is a perspective view of an ejector according to another embodiment of the present disclosure;

FIG. 16 is a perspective view of a frame according to another embodiment of the present disclosure, and

FIG. 17 is a schematic view of a method of using the detonator of FIG. 1.

### DETAILED DESCRIPTION

As used herein, the terms “detonation” and “firing” will be used interchangeably and as such, unless otherwise stated, the explicit use of either term is inclusive of the other term. Similarly, the terms “detonation mechanism” and “firing mechanism” will be used interchangeably. In describing preferred embodiments of the present disclosure, reference will be made to directional nomenclature. It is noted that this nomenclature is used only for convenience and that it is not intended to be limiting with respect to the scope of the invention. As used herein, when referring to a drone, the term “proximal” means towards the center of the drone. The term “distal” means away from the center of the drone.

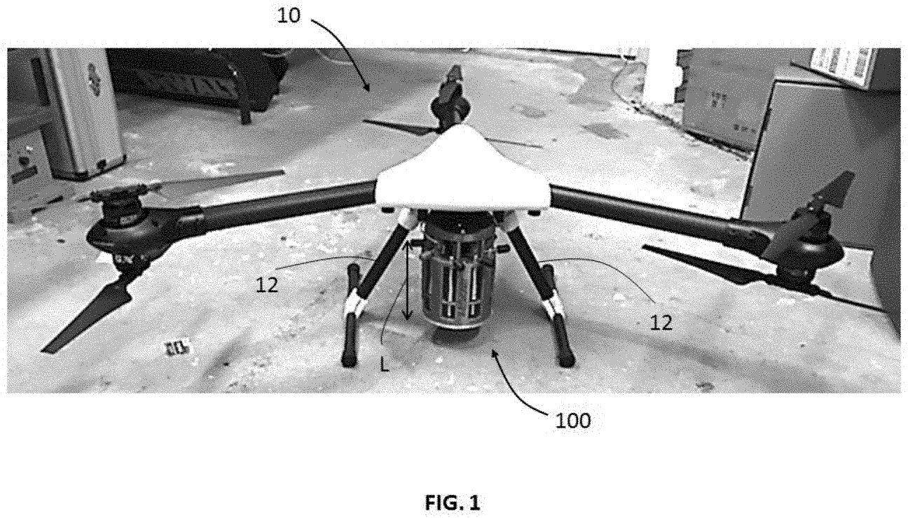

FIG. 1 shows a perspective view of a drone 10 with a detonator 100 according to one embodiment of the present device. While drone 10 shown here is a multi-rotor drone, detonator 100 of the present disclosure can be used in conjunction with any unmanned aerial vehicle (“UAV”) or manned aerial vehicle. Detonator 100 is configured to fit within stands 12 of drone 10 in order to minimize aerodynamic impact during drone flight. As more fully described below, material selection and design features of detonator 100 are specifically designed to minimize aerodynamic impact during drone flight. Detonator 100 can be integrated or permanently mounted on drone 10 or removably attached to a bottom of the drone's frame as shown in FIG. 1. Detonator 100 can also be integrated or attached to the top, side or suspended from the drone in other embodiments. Detonator 100 extends along a length L when attached to drone 10. Length L is less than the length of stands 12 such that detonator 100 does not contact the ground when the drone is placed on ground. This prevents damage to detonator 100 during drone landings.

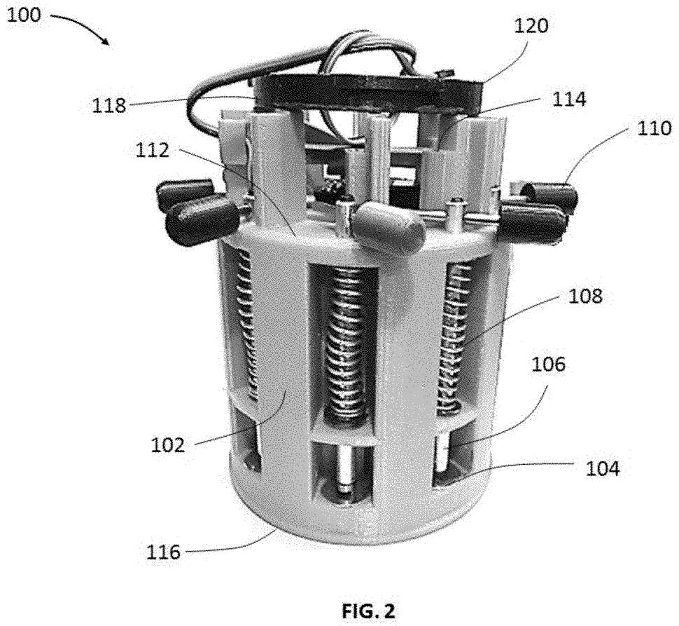

Referring now to FIGS. 2, 3 and 4, there is shown front views of detonator 100. Detonator 100 includes a frame 102 to house various components of the detonator. Frame 102 includes cut outs to accommodate these various components and also strategically located cut outs to reduce weight of detonator 100 for improved aerodynamics Frame 102 can be made of any light weight material with sufficient strength to house and sustain detonation of blank cartridges during drone flight. Frame 102 can be 3D printed with poly lactid acid (“PLA”) hybrid filaments or other suitable filaments to obtain the desired balance of strength and weight.

A plurality of housings 104 are arranged in a circular pattern at a base 116 of frame 102. Each housing including a housing aperture 130. Base 116 and housing 102 shown in this embodiment are made of T6061 aluminum. However, other similar materials providing sufficient strength to withstand detonations of blank cartridges and reduce weight for improved aerodynamics can be used. While this embodiment shows eight housings arranged in a circular pattern, other embodiments can have a different number of housings arranged in other patterns. For example, detonator 100 can have four housing arranged in a rectangular pattern. Detonator 100 can also be configured with a single housing in other embodiments. Base 116 is located at a distal end of frame 102. Each housing 104 has a corresponding firing rod 106 biased by springs 108. Springs 108 are compression springs in this embodiment, however, other spring types or biasing elements can be used to bias firing rods 106. Proximal ends of firing rods 106 include arms 110 extending generally transverse to the firing rods. A frame ring mount 118 is placed at a proximal end of frame 102 is configured to secure the various components of detonator 100. A distal surface of a drone ring mount 120 is attached to the detonator by connecting to the frame ring mount 118 as more fully described below. A proximal surface of the drone ring mount 120 is attachable with drone 10 to secure detonator 100 to drone 10.

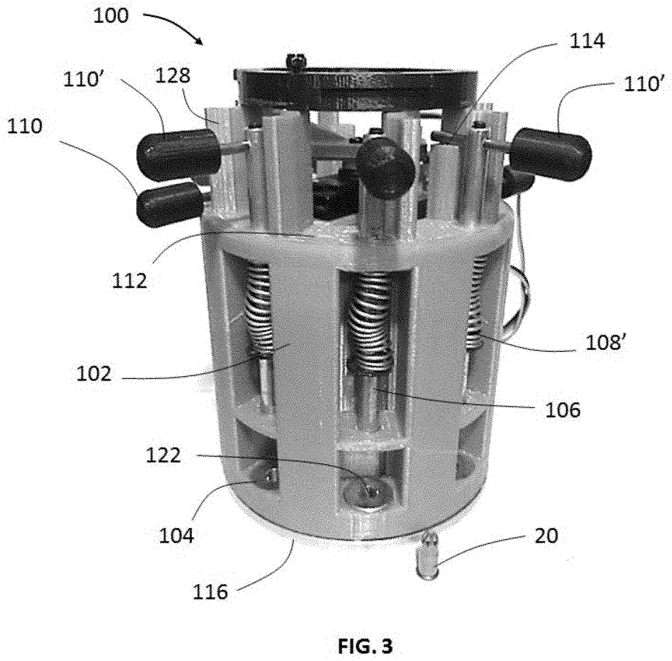

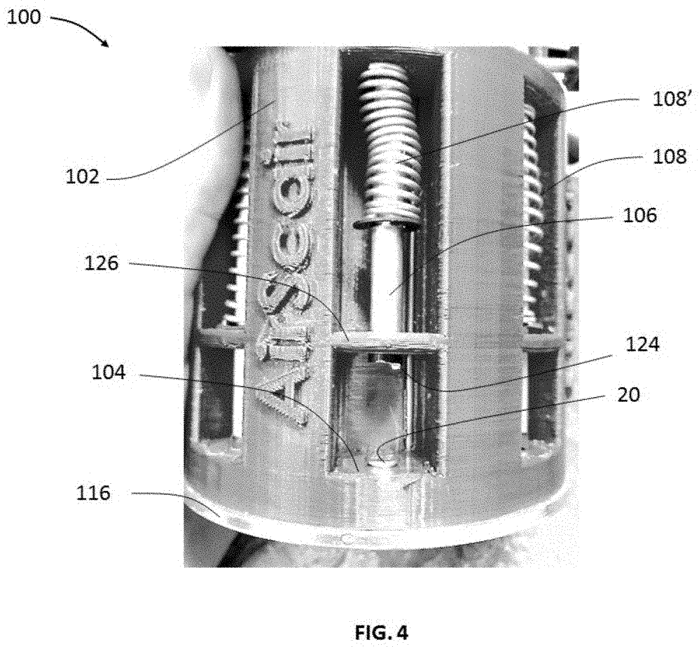

Each housing 104 defines a chamber 122 as best seen in FIG. 3. A blank cartridge 20 having a primer that is larger than chamber 122 can be placed in chamber 122 such that the blank cartridge 20 is secured within the chamber as best shown in FIG. 4. While a blank cartridge 20 is described in the present disclosure, any other detonation assembly can be placed in chamber 122 for detonation.

Firing rods 106 can be positioned in a loaded state or an unloaded state by moving the position of arm 110. FIG. 2 shows all firing rods in an unloaded state whereby a distal tip of the firing rod contacts the primer of blank cartridge 20. In the unloaded state, spring 108 is uncompressed and arm 110 contacts a distal surface 110 of frame 102. FIGS. 3 and 4 show an example of firing rods 106 in the loaded state whereby spring 108′ is in a compressed state and arms 110′ are positioned on a pad 114 of posts 128. As best seen in FIG. 4, a firing pin 124 attached to a distal tip of firing rod 106 is away from the primer of blank cartridge 20 in the unloaded state.

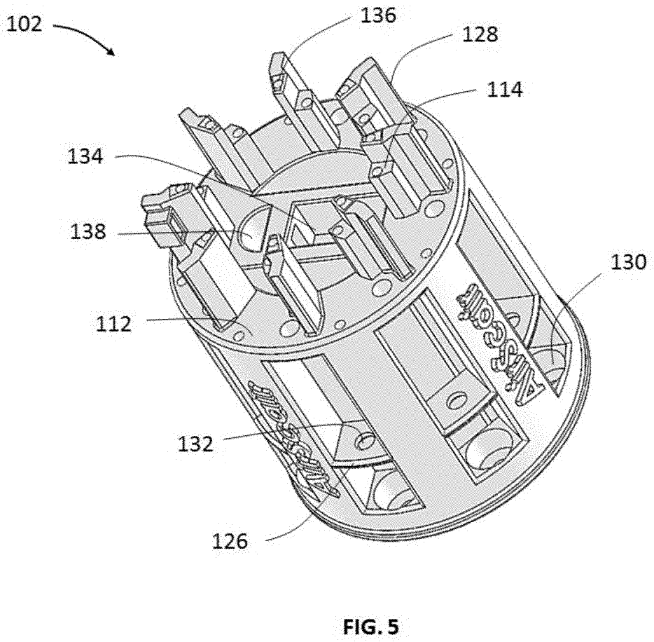

Referring now to FIG. 5, there is shown frame 102 of detonator 100. Frame 102 includes an actuator aperture 134 to house an actuator and associated components such as a power source, controls, etc. A second conduit 138 adjacent to the actuator aperture 134 is provided for additional components such as wiring, etc. Posts 128 are disposed in a circular pattern corresponding to housings 104 and include pad 114. Distal surface 112 is located adjacent to posts 128. Fastener apertures 136 are provided at a proximal end of posts 128 to allow connections with frame ring mount 118 (not shown). Frame 102 includes firing rod apertures 132 extending through platforms 126 to allow passage of the firing rods. Platforms 126 prevent springs 108 from contacting the primer of blank cartridge during detonation.

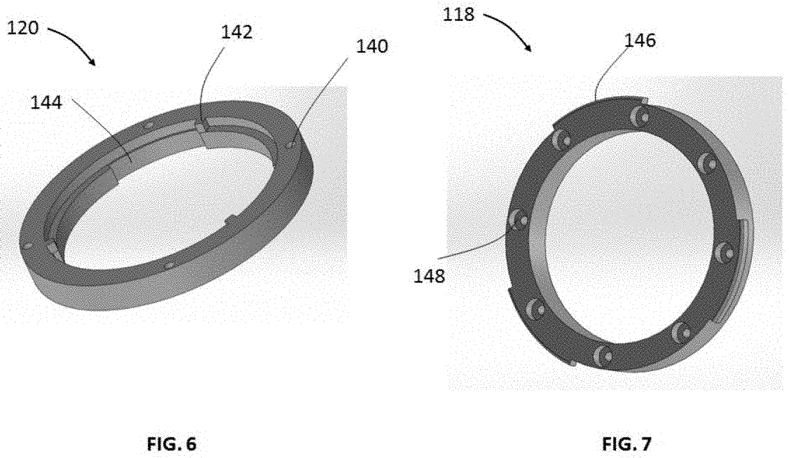

FIGS. 6 and 7 show details of drone ring mount 120 and frame ring mount 118 respectively. Drone ring mount 120 includes fastener holes 140 to allow detonator to drone 10. In this embodiment drone ring mount 120 can be attached to a base board (not shown) at the bottom of drone 120. Drone ring mount 120 includes flange openings 144 corresponding to flanges 146 on frame ring mount 118. Coupling the frame ring mount to the drone ring mount can be conveniently performed by aligning flanges 146 with flange openings 144, pushing frame ring mount towards the drone ring mount and rotating the flange ring mount until flanges 146 contact stoppers 142 on the drone ring mount. Detonator 100 can be detached from drone 10 by similarly detaching the frame ring mount from the drone ring mount. Therefore, an user can readily attach and detach detonator 100 from drone 10. While mounting rings with flanges are shown here, any other mechanisms such as a ball detent or snap fit connection can be used in other embodiments to attach and detach detonator 100 from drone 10.

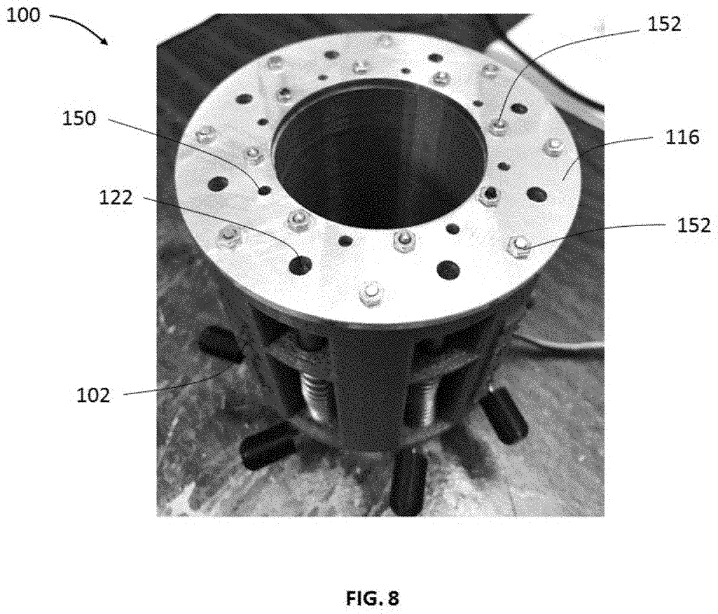

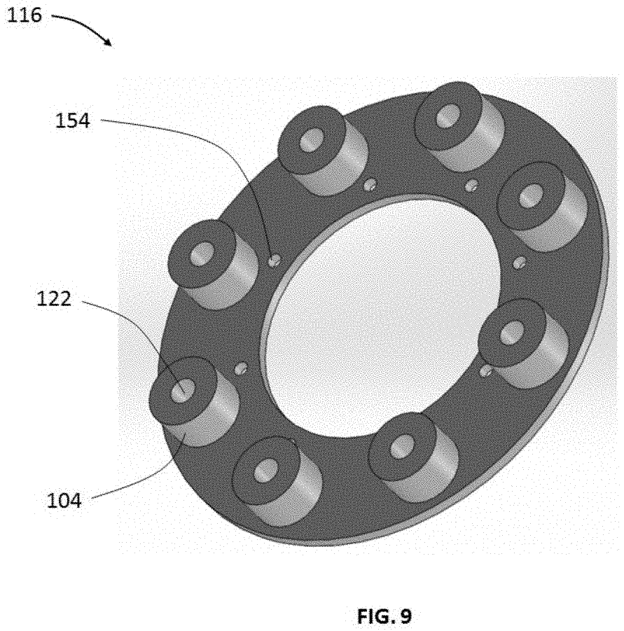

Referring now to FIGS. 8 and 9, there is shown details of base 116. Base 116 is secured to frame 102 by a plurality of fasteners 152 extending through fastener apertures 154 as best seen in FIG. 8. Chamber 122 extends through the base and provides an outlet for discharge gas and muzzle flash accompanying the detonation. Chamber 122 also amplifies the acoustic output of the blank cartridge detonation and directs the detonation towards a target zone. Sound amplifiers (not shown) can be attached to chamber 122 at the distal end (FIG. 8) to further amplify the detonation and improve the animal and bird controlling ability of detonator 100. Strategically located holes 150 provide weight reduction for improved aerodynamics without compromising the strength of base 116. Housings 104 extend proximally from the base plate to form chamber 122 as best shown in FIG. 9.

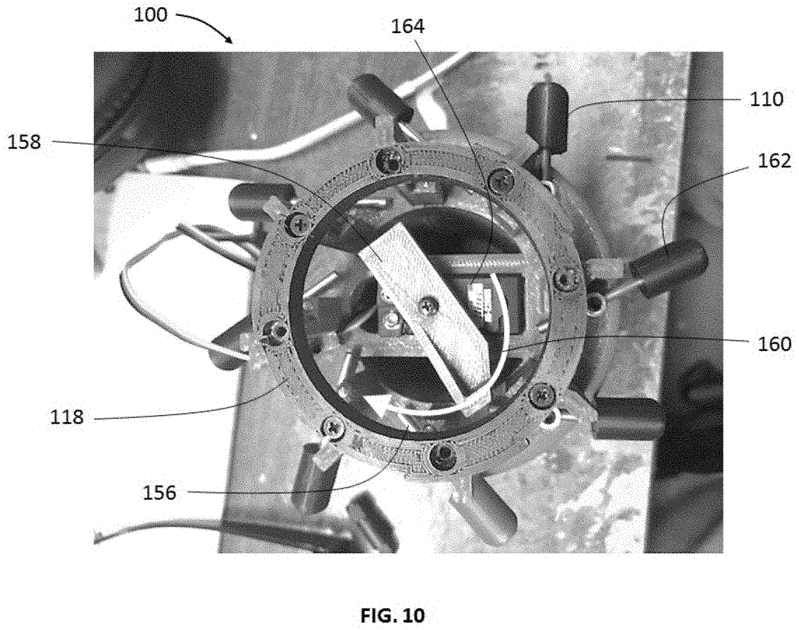

A top view of detonator 100 showing an actuator band 158 connected to an actuator mechanism 164 is shown in FIG. 10. Actuator mechanism 164 is placed in actuator aperture 134 of frame 102 and includes a power source and controls to rotate band 158 about a central axis as shown by a direction arrow 160. A leading edge 165 of band 158 pushes a finger 156 of arm 110 from pad 114 of post 128 to distal surface 112. A remote control source (not shown) in communication with actuator mechanism provides a control signal to initiate rotation of actuator band 158. While a mechanical actuator mechanism is described here, other embodiments of detonator 100 can have electrical, hydraulic or pressure based actuator mechanisms.

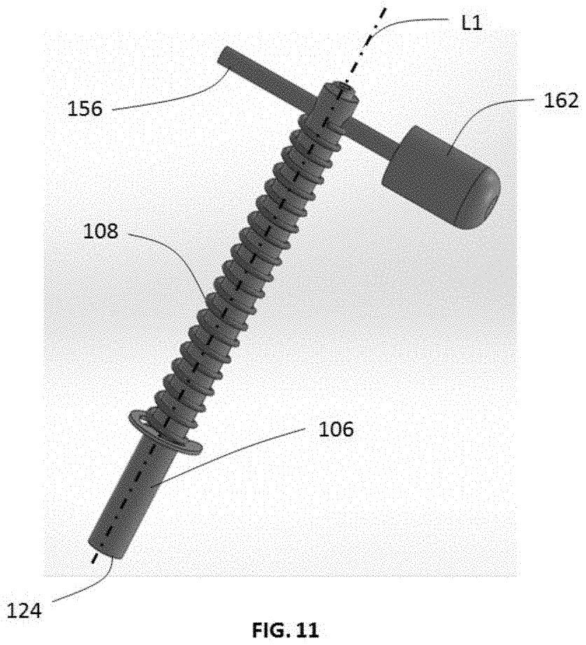

Referring now to FIG. 11, firing rod 106 details of detonator 100 are shown. Arm 110 includes a handle 162 and a finger 156 opposite the handle. Spring 108 is disposed around firing rod 106 along a central axis L1 extending through the firing rod. Firing rod 106 is made of aluminum to provide strength and weight savings for aerodynamics. Firing pin 124 is made of steel to sustain energy dissipated during detonation of the blank cartridge.

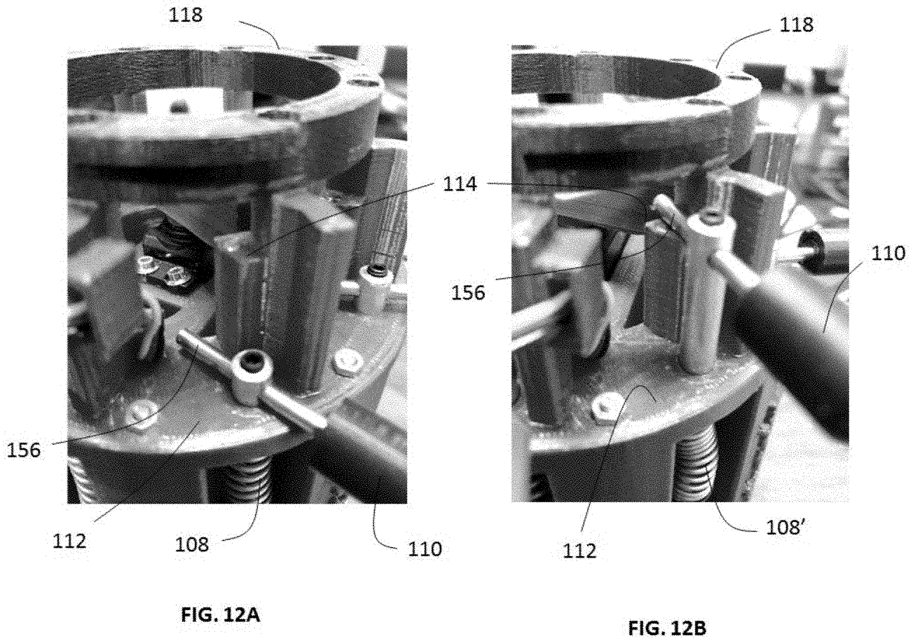

FIGS. 12A and 12B show the firing rod in an unloaded and a loaded state respectively. In the unloaded state, finger 156 of arm 110 rests on distal surface 112 as shown in FIG. 12A. To move firing rod 106 to the loaded state, the firing rod can be pulled back proximally by pulling on handle 162 until spring 108 is compressed and finger 156 is located above pad 114. Arm 110 can now be rotated using handle 162 about central axis L1 to place finger 156 on pad 114 as shown in FIG. 12B. A spring compression load of spring 108′ in the loaded state is equal to or greater than the detonation force required to detonate the blank cartridge. When actuator mechanism 164 rotates actuator band 158, the actuator band pushes finger 156 from pad 114 causing compressed spring 108′ to release the compression load to the firing rod such that the firing rod impact force is sufficient to trigger detonation of blank cartridge 20.

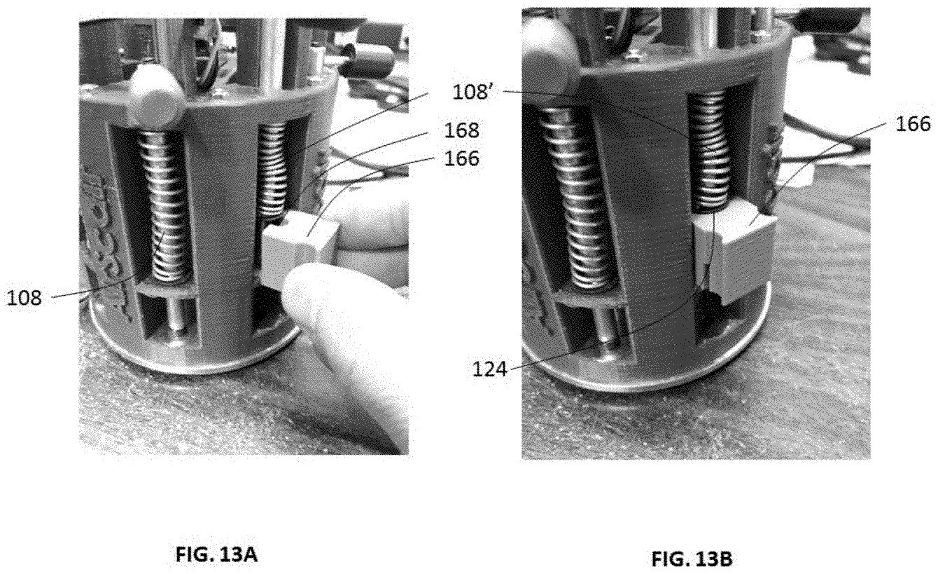

A safety stop 166 for detonator 100 according to another embodiment of the present disclosure is shown in FIGS. 13A and 13B. Stop 166 allows for safe loading and unloading of detonator 100 by preventing accidental discharge of firing rod 106. Stop 166 includes a groove 168 sized to receive firing rod 106 as best shown in FIG. 13A. When stop 166 is placed on platform 126 and in contact with the firing rod, stop 166 prevents distal travel of the firing rod as shown in FIG. 13B. Thus, stop 166 can be secured to detonator after placing blank cartridge 20 in housing 104 to prevent accidental discharge and safe handling of detonator 100 prior to drone operation. While a safety stop is shown in this embodiment, other safety mechanisms such as a spring lock, or arm lock, etc., can be used to prevent accidental discharge of detonator 100.

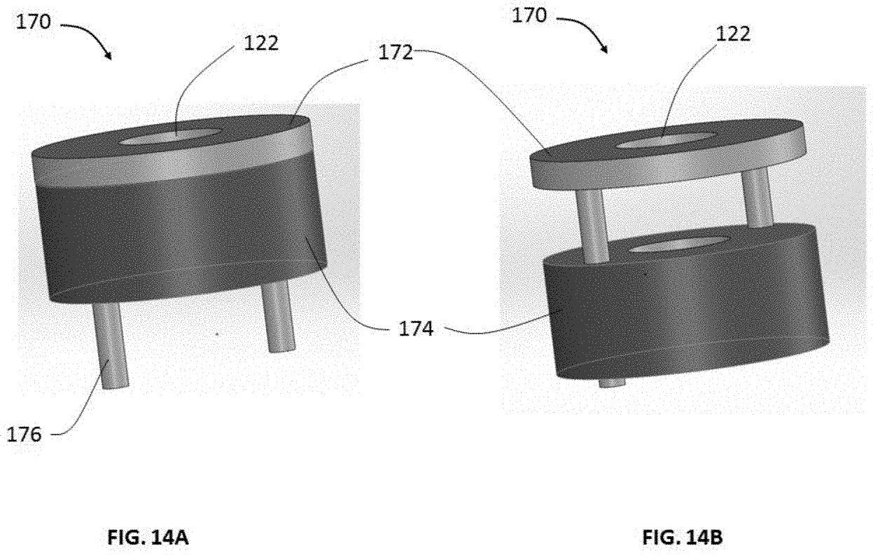

Referring now to FIGS. 14A and 14B, there is shown a housing 170 for detonator 100 according to another embodiment of the present disclosure. Housing 170 includes a first portion 172 and a moveable portion 174 to aid in removal of cartridge casings after detonation. Moveable portion 174 slides away from first portion 172 by rails 176 as shown in FIG. 14B. Cartridge casings (not shown) in housing 170 can be readily accessed and removed by sliding moveable portion 174 away from first portion 172.

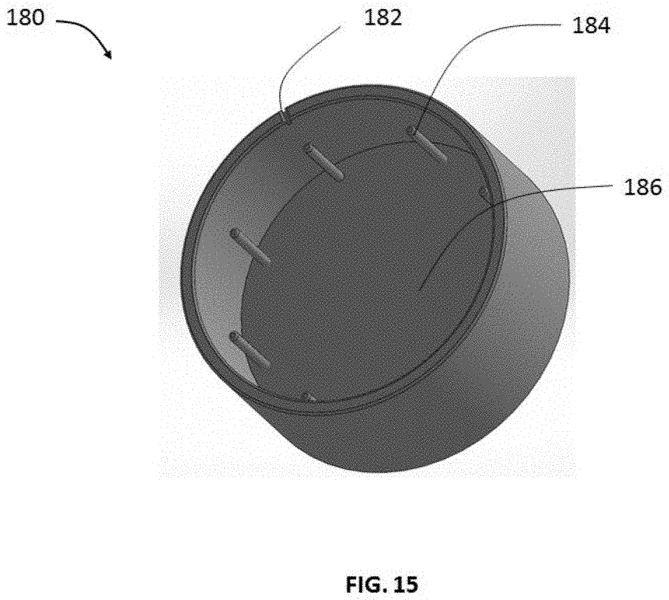

FIG. 15 shows an ejector 180 for detonator 100 according to another embodiment of the present disclosure. Ejector 180 is used to remove cartridge casings from housings 104. A plurality of ejector pins 184 arranged in a circular pattern around a base 186 correspond to the housing locations. In this embodiment, eight ejector pins 184 are shown corresponding to the eight housings of detonator 100. Ejector 180 includes markers 182 to allow for proper alignment of the ejector pins with chambers 12. Once ejector 180 is properly aligned with detonator 100, ejector 180 can be pushed towards the detonator to force out cartridge casings from the housings. All eight housings can be simultaneously evacuated by ejector 180.

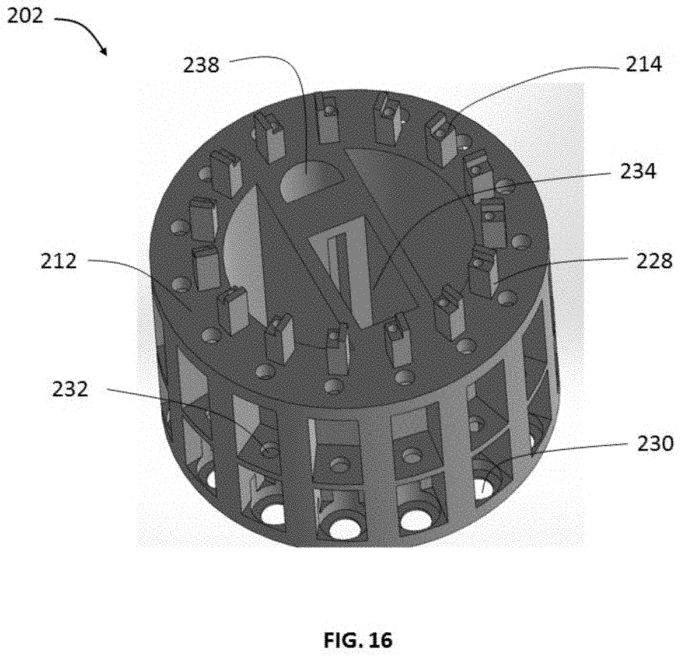

FIG. 16 shows a frame 202 of a detonator according to another embodiment of the present disclosure. Frame 202 is similar to frame 102, and therefore like elements are referred to with similar numerals within the 200-series of numbers. For instance, frame 202 includes housing apertures 230, posts 228 and pads 214. However, frame 202 has 15 housings with corresponding firing rods. Other embodiments may have different number of housings depending on the bird control application and/or type of drone being utilized to deploy the detonator.

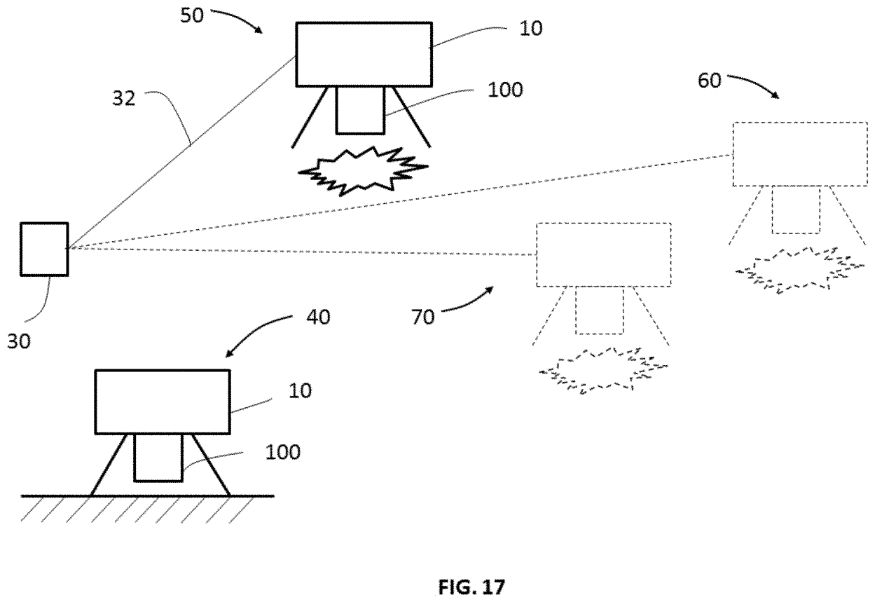

Referring now to FIG. 17, there is shown a schematic view of a method of bird control using drone 10 equipped with a detonator 100, which can be integrated with the drone or added on to the drone as an attachment. Blank cartridges 20 are placed in housings 104 of detonator 100 and the firing rods are pulled back to the loaded position as more fully described above. Safety stops 166 are then attached to firing rods 106 to prevent accidental discharge. Detonator 100 is then mounted to drone 10 at a location 40. Safety stops 166 are then removed prior to drone flight. Drone 10 can now be deployed to a target location 50 as shown in FIG. 17. An operator can utilize a user-controller 30, which can be a drone radio controller, to control the flight of the drone and which is also configured to allow the user to send a control signal 32 triggering actuator mechanism 164 to detonate one or more blank cartridges at target location 50. A wireless transceiver located on drone 10 or detonator 100 is configured to communicate with user-controller 30 allowing an user to actuate detonation from a remote location. The wireless transceiver can communicate with user-controller 30 through any wireless technologies, such as radio frequency or Wi-Fi. Different modes of detonation can be actuated by the user such as a single shot mode or multi-shot burst mode, depending on the application and needs and reactions from the animals to be controlled. For example, user-controller 30 can include an actuator such as a button or rocker switch whereby an operator can initiate a single detonation by pressing down and releasing the button or switch, or simply pressing down and holding the button or switch for continuous multiple detonations based on the length of time the button or switch is actuated. Similar detonations can be carried out at locations 60 and 70 to provide bird or animal control over a target area such as a farm, airport, golf course, athletic field, or other such locations prone to bird or animal nuisance. Detonator 100 can detonate blank cartridges during any flight mode and provides an operator with the ability to trigger detonations at any desired location. Drone 10 can be equipped with navigational capabilities such as GPS, Waypoint GPS navigation, cameras or thermal imaging to further aid in deploying the drone to desired target area. Drone 10 can be shaped to resemble natural predators of pest animals and birds to enhance deterrence. Springs or other dampers can be added to detonator 100 to minimize the impact of detonation recoil. In other embodiments, the actuator mechanism can simultaneously trigger firing rods for multiple housings, such as two housings arranged in opposite directions, to cancel the effect of recoil.

Furthermore, although the invention disclosed herein has been described with reference to particular features, it is to be understood that these features are merely illustrative of the principles and applications of the present invention. It is therefore to be understood that numerous modifications, including changes in the sizes of the various features described herein, may be made to the illustrative embodiments and that other arrangements may be devised without departing from the spirit and scope of the present invention. In this regard, the present invention encompasses numerous additional features in addition to those specific features set forth in the paragraphs below. Moreover, the foregoing disclosure should be taken by way of illustration rather than by way of limitation as the present invention is defined in the examples of the numbered paragraphs, which describe features in accordance with various embodiments of the invention, set forth in the claims below.

1. A drone for animal and bird control comprising a detonator, the detonator comprising:
a housing defining a chamber to receive and retain a blank cartridge;
a biased element moveable from a first position to a second position; and
an actuator to move the biased element from the first position to the second position,
wherein a distal end of the biased element is away from the blank cartridge in the first position and contacts the blank cartridge in the second position to detonate the blank cartridge.

2. The drone of claim 1, wherein the detonator is detachably connected to a drone.

3. The drone of claim 2, wherein the distal end contacts the blank cartridge in the second position to detonate the blank cartridge during drone flight.

4. The drone of claim 1, wherein a blank cartridge dimension is greater than a chamber dimension such that the blank cartridge forms an interference fit with the chamber.

5. The drone of claim 1, wherein the biased element is a spring-loaded rod.

6. The drone of claim 5, wherein the rod includes a firing pin on a distal end.

7. The drone of claim 5, wherein the spring is a compression spring, being compressed with a compression spring load when the spring-loaded rod is in the first position.

8. The drone of claim 7, wherein the compression spring load is released by moving the spring-loaded rod from the first position to the second position.

9. The drone of claim 8, wherein the compression load is equal to or greater than a detonation force required for detonation of the blank cartridge.

10. The drone of claim 9, wherein a proximal portion of the spring-loaded rod has an arm extending transverse to the spring-loaded rod, the spring-loaded rod being rotatable about a central axis such that the arm can be moved from a first lateral position to a second lateral position.

11. The drone of claim 10, wherein when the spring-loaded rod is in the first position and the arm is in the first lateral position, at least a portion of the arm rests on a proximal surface of the detonator.

12. The drone of claim 10, wherein when the spring-loaded rod is in the second position and the arm is in the second lateral position, at least a portion of the arm rests on a distal surface of the detonator.

13. The drone of claim 12, wherein the actuator includes a movable band, the band being configured to move the spring-loaded rod from the first position to the second position by moving the arm from the first lateral position to the second lateral position.

14. The drone of claim 1, wherein the actuator is in communication with a remote control source such that the actuator is initiated by the remote control source to detonate the blank cartridge.

15. The drone of claim 1, wherein the actuator is initiated by a timer to detonate the blank cartridge.

16. A drone detonator for animal and bird control, the detonator comprising:
a plurality of housings, each housing defining a chamber to receive and retain a blank cartridge;
a plurality of biased elements corresponding to the plurality of housings, each biased element moveable from a first position to a second position; and
an actuator to move the biased elements from the first positions to the second positions,
wherein a distal end of the biased elements are away from the blank cartridges in a first position and contacts the blank cartridges in the second position to detonate the blank cartridges.

17. The drone detonator of claim 16, wherein the plurality of housings are arranged in a circular pattern.

18. The drone detonator of claim 17, wherein the actuator is configured to individually detonate each of the blank cartridges.

19. A method for animal and bird control comprising the steps of:
attaching a drone detonator to a drone, the detonator having an actuator, a firing rod and a blank cartridge;
flying the drone to a target zone, and
detonating the blank cartridge by activating the actuator causing the firing rod to contact the blank cartridge.

20. The method of claim 19, wherein the step of detonating the blank cartridge is performed by activating the actuator via a remote control source, the actuator being in communication with the remote control source.
